(19) United States
(12) Patent Application Publication
(10) Pub. No.: US 2010/0044182 A1
(43) Pub. Date: Feb. 25, 2010

(54) WET TYPE MULTI-PLATE CLUTCH

(75) Inventors: MASAKI SAKABE, Fukuroi-shi (JP); Atsushi Sagae, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-WARNER K.K.

(21) Appl. No.: 12/542,275

(22) Filed: Aug. 17, 2009

(30) Foreign Application Priority Data
Aug. 19, 2008 (JP) 2008-210626

(51) Int. Cl. F16D 13/00

(52) U.S. Cl. 192/113.36

(57) ABSTRACT

The present invention provides a wet type multi-plate clutch comprising a friction plate including friction materials secured to both surfaces of a core plate provided at its inner diameter side with a spline portion, a notch groove opened to the inner diameter side and having a terminal portion positioned between the inner diameter side and the outer diameter side and a through groove extending from the inner diameter side to the outer diameter side, and a separator plate provided at its outer diameter side with a spline portion, and wherein a retracting amount at the inner diameter side of the friction material secured to the friction plate is greater than a retracting amount at the outer diameter side.

This application claims the benefit of Japanese Patent Application No. 2008-210626, filed on Aug. 19, 2008, which is hereby incorporated by reference in its entirety.

### BACKGROUND OF THE INVENTION

1. Field of the Invention

The present invention relates to a wet type multi-plate clutch used as a clutch or a brake of an automatic transmission of a motor vehicle. More particularly, the present invention relates to an improvement in a retracting amount at an inner diameter side of a friction plate.

2. Related Background Art

In general, in a wet type multi-plate clutch, friction plates and separator plates are arranged alternately between a drum and a hub of a clutch or a brake, and engagement and disengagement of the clutch is performed by pressing and releasing of a clutch piston.

Further, in recent years, reduction of fuel consumption in a motor vehicle has been requested more and more, and, also in an automatic transmission, in order to reduce power loss in the disengagement of the clutch, further reduction of drag torque between the friction plate and the separator plate has been requested.

In general, in many cases, the wet type multi-plate clutch used in the automatic transmission is designed so that lubricant oil can be discharged easily from an inner peripheral side to an outer peripheral side of the friction plate in order to reduce the power loss, thereby reducing the drag torque. For example, Japanese Patent Application Laid-open Nos. 2006-132581 and 2007-132362 suggest the reduction of the drag torque.

While the friction plates and the separator plates are being rotated relatively, drag is generated by the lubricant oil existing between the plates. Such drag is generally called as idle rotation drag, and, in order to enhance the reduction of fuel consumption, the idle rotation drag must be reduced as small as possible.

To this end, in the above-mentioned Japanese Patent Application Laid-open No. 2006-132581, to further reduce the idle rotation drag, an outer diameter of a friction material adhered to the friction plate is decreased so that, at an outer diameter portion of the plate, a clearance between the separator plate and the friction plate is increased, thereby reducing the idle rotation drag.

Further, in the above-mentioned Japanese Patent Application Laid-open No. 2007-132362, oil grooves only opened to an outer diameter side are provided in the surface of the friction material so that oil sucked onto the friction surface from an oil passage can be discharged smoothly toward the outer diameter side, thereby reducing the drag torque during the idle rotation.

However, in recent years, to enhance transmission response in order to enhance the reduction of fuel consumption and also to enhance power performance, the clearance between the friction plate and the separator plate has been decreased in comparison with the conventional cases, so that the drag torque generated by the interposed oil film tends to be increased.

The oil supplied to the oil passage extending from the inner diameter side to the outer diameter side is drawn onto the friction material by the rotation, and, if the drawn oil enters into the clearance between the friction plate and the separator plate, the oil is hard to be discharged from the clearance; this tendency is noticeable particularly when the clearance between the friction plate and the separator plate is small and particularly at an area where revolution per minute is small, so that the drag torque generated by viscosity between the friction material and the associated separator plate becomes greater.

The oil groove extending between the inner diameter side and the outer diameter side serves to supply the oil to the friction surface and to discharge the oil. In this case, the flow of the oil from the oil groove to the friction surface is greatly influenced by the configuration of the oil groove and/or both dull corners of the oil groove, which affects an influence upon the idle rotation torque and a friction property during the engagement, thereby causing dispersion in quality.

In the conventional friction plates, since the oil is not adequately discharged from the friction surface, the requirement for further reducing the drag torque has not been satisfied. Particularly at the area where the revolution per minute is small, the oil existing between the friction plate and the separator plate is not discharged adequately, so that the drag torque cannot be reduced.

Although there is a method for reducing the drag torque by decreasing the outer diameter of the friction material adhered to the friction plate, in recent years, since a thickness of the friction material has been decreased more and more, even when the outer diameter of the friction material is decreased, the clearance between the friction plate and the separator plate is not increased adequately, so that the satisfying effect for reducing the drag torque cannot be obtained, and, when the outer diameter of the friction material is decreased, since an average radius of the engaging area of the friction surface is decreased, this affects a bad influence upon a capacity for transmitting the torque. Accordingly, it cannot say that the countermeasure disclosed in the above-mentioned Japanese Patent Application Laid-open No. 2006-132581 is effective to reduce the idle rotation drag.

However, in order to satisfy the requirements for reducing the size and weight of the modern automatic transmission, it is desired that friction capacity for each friction plate is increased. To this end, the increase in the number of grooves formed in the friction plate and the magnitude of the groove has been limited severely.

### SUMMARY OF THE INVENTION

Accordingly, an object of the present invention is to provide a wet type multi-plate clutch having friction plates in which a coefficient of friction during an idle rotation is small, there is no dispersion in friction property in the engagement thereby to stabilize the quality, shock during the engagement is small, there is good heat resistance and drag torque during the idle rotation can be reduced considerably in comparison with conventional clutches.

To achieve the above object, the present invention provides a wet type multi-plate clutch including friction plates each of which includes friction materials secured to both surfaces of a core plate provided at its inner diameter side with a spline portion, a notch groove opened to the inner diameter side and having a terminal portion positioned between the inner and outer diameter sides and a through groove extending from the inner diameter side to the outer diameter side, and separator plates each of which is provided at its outer diameter side with a spline portion, and wherein a retracting amount at the inner diameter side of the friction material secured to the friction plate is greater than a retracting amount at the outer diameter side, and an inner diameter edge of the separator plate is substantially flush with an inner diameter edge of the friction material of the friction plate in a radial direction.

According to the present invention, the following advantages can be obtained.

Since the retracting amount at the inner diameter side of the friction material secured to the friction plate is greater than the retracting amount at the outer diameter side and the inner diameter edge of the separator plate is substantially flush with the inner diameter edge of the friction material of the friction plate in the radial direction, the drag torque can be reduced without decreasing a torque capacity.

Further, in comparison with the conventional clutches, since a space portion defined at the inner diameter portion by a clutch hub fitted into the spline portion of the friction plate and the friction plate and the separator plate becomes great, lubricant oil supplied from the inner diameter portion can be discharged smoothly toward the outer diameter portion through grooves extending between the inner diameter portion to the outer diameter portion.

Since there are provided grooves each having the terminal portion positioned between the inner and outer diameter portions, a separating effect is increased effectively, and, by selecting the retracting amount to 15% −35% and by selecting the number of the through grooves to become greater than the number of the grooves having the terminal portions positioned between the inner and outer diameter portions by two times to five times, even under a condition that the large amount of lubricant oil is used, the effect for discharging the lubricant oil is enhanced, thereby providing a wet type multi-plate clutch in which friction performance and endurance similar to the conventional ones can be maintained and the idle rotation drag is further reduced.

The term “retracting amount”used in the specification is defined as follows. As shown in FIG. 2, a retracting amount R at the inner diameter side corresponds to a distance between a bottom of the spline and an inner diameter end of the friction material at the inner diameter side of the friction material, and a retracting amount S at the outer diameter side corresponds to a distance between an outer diameter end of the core plate and an outer diameter end of the friction material. Here, when it is assumed that a distance between the bottom of the spline of the core plate and the outer diameter end of the core plate is E, a rate of the retracting amount at the inner diameter side is denoted by R/E and a rate of the retracting amount at the outer diameter side is denoted by S/E.

Further features of the present invention will become apparent from the following description of exemplary embodiments with reference to the attached drawings.

### BRIEF DESCRIPTION OF THE DRAWINGS

FIG. 1 is an axial partial sectional view of a wet type multi-plate clutch having a friction plate according to the present invention.

FIG. 2 is a partial front view showing a first embodiment of a friction plate used in the wet type multi-plate clutch according to the present invention.

FIG. 3 is a partial front view showing a second embodiment of a friction plate used in the wet type multi-plate clutch according to the present invention.

FIG. 4 is a partial front view showing a third embodiment of a friction plate used in the wet type multi-plate clutch according to the present invention.

### DETAILED DESCRIPTION OF THE INVENTION

Now, the present invention will be fully explained with reference to the accompanying drawing. Incidentally, the same parts or elements are designated by the same reference numerals.

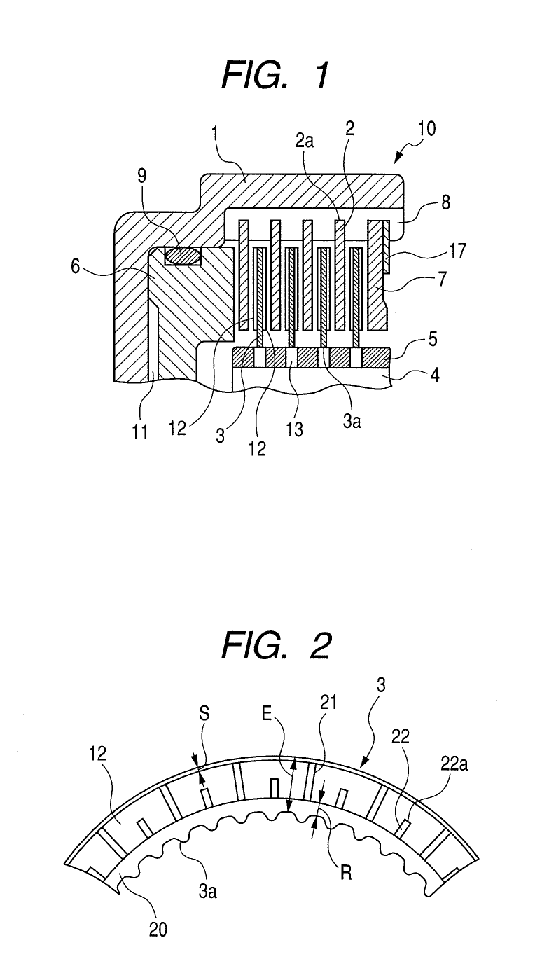

FIG. 1 is an axial partial sectional view of a wet type multi-plate clutch 10 having a friction plate according to the present invention.

The wet type multi-plate clutch 10 comprises a substantially cylindrical clutch case 1 having an axial open one end, a hub 4 coaxially disposed within the clutch case 1 for a relative rotation, annular separator plates 2 disposed in a spline portion 8 provided on an inner periphery of the clutch case 1 for an axial shifting movement, and annular friction plates 3 disposed in a spline portion 5 provided on an outer periphery of the hub 4 and arranged alternately with the separator plates 2 in an axial direction and to which friction materials are adhered. Plural separator plates 2 and plural friction plates 3 are provided. Each friction plate 3 is provided at its inner periphery with a spline 3a which is fitted into the spline portion 5 of the hub 4.

The wet type multi-plate clutch 10 further includes a piston 6 for pressing the separator plates 2 against the friction plates 3 to engage the clutch, a backing plate 7 provided on the inner periphery of the clutch case 1 to fixedly hold the separator plates 2 and the friction plates 3 at an axial one end, and a stop ring 17 for holding the backing plate.

As shown in FIG. 1, the piston 6 is disposed within a closed end portion of the clutch case 1 for an axial sliding movement. An O-ring 9 is interposed between an outer peripheral surface of the piston 6 and an inner surface of the clutch case 1. Further, a seal member (not shown) is interposed between an inner peripheral surface of the piston 6 and an outer peripheral surface of a cylindrical portion (not shown) of the clutch case 1. Accordingly, an oil-tight hydraulic chamber 11 is defined between an inner surface of the closed end portion of the clutch case 1 and the piston 6.

Friction materials 12 having predetermined coefficient of friction are secured to axial both surfaces of each friction plate 3 held by the hub 4 for an axial sliding movement. However, the friction materials 12 may be provided on one surface of the friction plate 3 and one surface of the separator plate 2. Further, lubricant oil supplying ports 13 extending through the hub 4 in a radial direction are provided in the hub, thereby supplying lubricant oil from an inner diameter side to an outer diameter side of the wet type multi-plate clutch 10.

In the wet type multi-plate clutch 10 having the above-mentioned arrangement, the clutch is engaged and disengaged in the following manner. A condition shown in FIG. 1 is a clutch disengaged or released condition in which the separator plates 2 are separated from the friction plates 3. In the released condition, the piston 6 is urged against an end surface of the closed end portion of the clutch case 1 by a biasing force of a return spring (not shown).

From this condition, to engage the clutch, oil pressure is supplied to the hydraulic chamber 11 defined between the piston 6 and the clutch case 1. As the oil pressure is increased, the piston 6 is shifted to the right (FIG. 1) in the axial direction in opposition to the biasing force of the return spring (not shown), thereby closely contacting the separator plates 2 with the friction plates 3. In this way, the clutch is engaged.

After the engagement, in order to release the clutch again, the oil pressure is released from the hydraulic chamber 11. When the oil pressure is released, the piston 6 is shifted by the biasing force of the return spring (not shown) until the piston abuts against the closed end portion of the clutch case 1. In this way, the clutch is released or disengaged.

### First Embodiment

FIG. 2 is a partial front view showing a first embodiment of the friction plate 3 used in the wet type multi-plate clutch of FIG. 1. The friction plate 3 is formed by securing annular friction materials 12 onto an annular steel core plate 20.

Through grooves 21 extending through from an inner diameter side to an outer diameter side of the friction material 12 and notch grooves 22 each having a terminal end portion positioned between the inner and outer diameter sides of the friction material are provided in the friction material 12. The plural through grooves 21 and the plural notch grooves 22 are arranged equidistantly and alternately along a circumferential direction.

Each notch groove 22 having the terminal portion positioned between the inner and outer diameter portions has a terminal portion 22a extending from an inner diameter side opening portion to a substantially intermediate position of the friction material 12.

By providing the through grooves 21, the lubricant oil can be discharged smoothly toward the outer diameter side. Further, by providing the notch grooves 22 opened in the inner diameter portion and having the terminal portions positioned between the inner and outer diameter sides, the separating effect can be increased more effectively.

A retracting amount R at the inner diameter side of the friction material 12 secured to the friction plate 3 is greater than a retracting amount S at the outer diameter side. In this case, by designing so that the inner diameter of the separator plate 2 is increased and an inner diameter edge of the separator plate 2 becomes substantially flush with an inner diameter edge of the friction material 12 of the friction plate 3, the drag torque in the dragging portion of the inner diameter portion of the friction material generated by the lubricant oil existing between the friction material 12 of the friction plate 3 of the conventional inner diameter portion and the separator plate 2 can be eliminated, thereby reducing the idle rotation drag of the wet type multi-plate clutch greatly.

### Second Embodiment

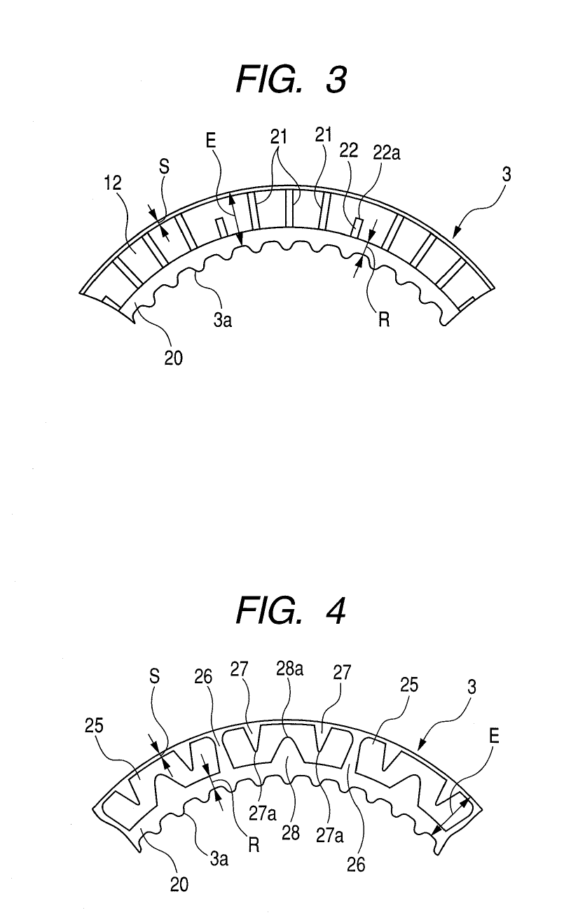

FIG. 3 is a partial front view showing a second embodiment of the friction plate used in the wet type multi-plate clutch of FIG. 1. The second embodiment has the same fundamental construction as the first embodiment, but differs from the first embodiment with respect to the number of the through grooves 21. In the second embodiment, the number of the through grooves 21 is selected to be greater than the number of the notch grooves 22 having the terminal portions positioned between the inner and outer diameter portions by three times. Also in the second embodiment, it is designed so that the inner diameter edge of the separator plate 2 becomes substantially flush with the inner diameter edge of the friction material 12 of the friction plate 3.

By selecting the number of the through grooves 21 to be greater than the number of the notch grooves 22 having the terminal portions positioned between the inner and outer diameter sides by two times to five times, also in a condition that a large amount of lubricant oil is used, the effect for discharging the lubricant oil is enhanced. Also in the second embodiment, the retracting amount R at the inner diameter side of the friction material 12 secured to the friction plate 3 is greater than the retracting amount S at the outer diameter side.

By selecting the number of the through grooves 21 to be greater than the number of the notch grooves 22 having the terminal portions positioned between the inner and outer diameter sides by two times to five times and by setting the retracting amounts as mentioned above, a wet type multi-plate clutch in which friction performance and endurance similar to the conventional ones can be maintained and the idle rotation drag is further reduced can be obtained.

### Third Embodiment

FIG. 4 is a partial front view showing a third embodiment of the friction plate used in the wet type multi-plate clutch of FIG. 1. In the third embodiment, the friction material 12 is constituted by a combination of a plurality of friction material segments 25, rather than the annular friction material. The friction material segments 25 having the same configurations are arranged equidistantly along a circumferential direction and secured to the core plate 20. Also in the third embodiment, it is designed so that the inner diameter edge of the separator plate 2 becomes substantially flush with the inner diameter edges of the friction material segments 25 of the friction plate 3.

A clearance from which the surface of the core plate 20 is exposed is provided between the friction material segments 25, which clearance constitutes a through groove 26 extending from the inner diameter side to the outer diameter side. Further, in each friction material segment 25, a notch groove 28 opened to the inner diameter side at a substantially intermediate portion of the segment in the circumferential direction and having a terminal portion 28a positioned between the inner and outer diameter sides is formed. Further, at both sides of the notch groove 28 in the circumferential direction, notch grooves 27 each opened to the outer diameter side and each having a terminal portion 27a positioned between the inner and outer diameter sides are formed.

The notch groove 28 is formed before the friction material segment 25 is secured to the core plate 20. However, after the friction material segment 25 is secured to the core plate 20, the notch groove 28 may be formed by the press working of the friction material segment 25.

In the first to third embodiments as mentioned above, the retracting amount R at the inner diameter side can be set to a magnitude of 15%-35% of a distance E between a bottom of the spline and an outer diameter end of the friction plate 3 (core plate 20). That is to say, R/E is 0.15 to 0.35. By setting so, due to a geometrical effect between such setting and the grooves having the terminal portions positioned between the inner and outer diameter sides, the separating effect can be increased more effectively.

Further, as shown in FIG. 1, in the above-mentioned various embodiments, the separator plate 2 is designed to have the same inner diameter as a diameter of the inner diameter end of the friction material 12 or the friction material segment 25 of the friction plate 3. In other words, it is designed so that the inner diameter edge of the separator plate 2 becomes substantially flush with the inner diameter edge of the friction plate 3 in the circumferential direction. With this arrangement, since a space portion defined at the inner diameter portion by the clutch hub 4 fitted in the spline portion of the friction plates 3 and the friction plate 3 and the separator plate 2 becomes greater, the lubricant oil supplied from the inner diameter portion can be discharged smoothly toward the outer diameter side through the grooves extending from the inner diameter side to the outer diameter side.

Although the friction material 12 or the friction material segment 25 is fixedly secured to the core plate 20 by an adhesive, a seal-like friction material segment 25 or friction material 12 on rear surface of which an adhesive is coated may be rested on the core plate 20 and may be fixedly secured to the core plate by pressing and heating.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A wet type multi-plate clutch comprising:
a friction plate including friction materials secured to both surfaces of a core plate provided at its inner diameter side with a spline portion, a notch groove opened to the inner diameter side and having a terminal portion positioned between the inner diameter side and the outer diameter side and a through groove extending from the inner diameter side to the outer diameter side; and
a separator plate provided at its outer diameter side with a spline portion;
and wherein
a retracting amount at the inner diameter side of said friction material secured to said friction plate is greater than a retracting amount at the outer diameter side, and an inner diameter edge of said separator plate is substantially flush with an inner diameter edge of said friction material of said friction plate in a radial direction.

2. A wet type multi-plate clutch according to claim 1, wherein the retracting amount at the inner diameter side is a magnitude of 15%-35% of a distance between a bottom of said spline of said core plate and an outer diameter end of said core plate.

3. A wet type multi-plate clutch according to claim 1, wherein the number of said through grooves is greater than the number of said notch grooves by two times to five times.

4. A wet type multi-plate clutch according to claim 1, wherein said friction material is constituted by friction material segments and said through groove is provided between said friction material segments.
